(19) United States
(12) Patent Application Publication
(10) Pub. No.: US 2015/0277036 A1
(43) Pub. Date: Oct. 1, 2015

(54) Apparatus and Method for an Optical Waveguide Edge Coupler for Photonic Integrated Chips

(71) Applicant: FutureWei Technologies, Inc., Plano, TX (US)

(72) Inventors: Jia Jiang, Kanata (CA); Dominic John Goodwill, Ottawa (CA); Eric Bernier, Ottawa (CA)

(73) Assignee: FUTUREWEI TECHNOLOGIES, INC., Plano, TX (US)

(21) Appl. No.: 14/228,703

(22) Filed: Mar. 28, 2014

(51) Int. Cl. G02B 6/12; G02B 6/132; G02B 6/136

(52) U.S. Cl. CPC G02B 6/12; G02B 6/136; G02B 6/132

(57) ABSTRACT

Embodiments are provided for photonic chip waveguides with improved coupling efficiency to optical fibers. In an embodiment, a photonic chip comprises a semiconductor substrate, a dielectric layer on the substrate, and a tapered silicon or semiconductor waveguide embedded in the dielectric layer. The dielectric layer has lower optical refractive index than the tapered waveguide and serves as a cladding for the tapered waveguide. The chip further includes, on the substrate, a dielectric waveguide adjacent to the dielectric layer. The tip of the tapered waveguide is embedded in the dielectric waveguide. The dielectric waveguide serves to couple the tapered waveguide to an optical fiber, enlarge and better confine the light propagation mode from the taper waveguide to the fiber.

### TECHNICAL FIELD

The present invention relates to photonic chips, and, in particular embodiments, to an apparatus and method for an optical waveguide edge coupler for photonic integrated chips.

### BACKGROUND

Silicon nanophotonic chips, such as in silicon on insulator (SOI) platforms, typically include waveguide cross-sections in the sub-micron scale, are highly compact and comprise a high level of function integration. To implement silicon chips in optical communications networks, the optical light to/from the chips need to be coupled to optical fibers or other waveguides. The optical fibers typically have around a 10 micrometers (μm) mode field dimension (MFD). A substantial MFD mismatch, referred to as a coupling mismatch, between the light propagating mode in silicon chip waveguide and the optical fiber causes significant loss of optical power at this interface. The mismatch problem can significantly hinder the optical transmission efficiency. Various schemes have been explored to improve the optical coupling, with various degrees of improvement. The coupling efficiency due to the mismatch remains a challenge. There is a need for an improved waveguide coupler design that enhances the coupling efficiency in photonic integrated chips.

### SUMMARY OF THE INVENTION

In accordance with an embodiment, a photonic chip comprises a semiconductor substrate, a dielectric layer on the substrate, and a tapered waveguide embedded in the dielectric layer. The dielectric layer has lower optical refractive index than the tapered waveguide and serves as a cladding for the tapered waveguide. The chip further includes, on the substrate, a dielectric waveguide adjacent to the dielectric layer. The tip of the tapered waveguide is embedded in the dielectric waveguide.

In accordance with another embodiment, a photonic chip comprises a dielectric carrier, a dielectric layer on the dielectric carrier, and a semiconductor waveguide embedded in the dielectric layer. The dielectric layer has a lower optical refractive index than the semiconductor waveguide and serves as a cladding for the semiconductor waveguide. The chip further includes, on the dielectric carrier, a dielectric waveguide adjacent to the dielectric layer, and facing the semiconductor waveguide.

In accordance with another embodiment, a method for fabricating a photonic chip includes placing a dielectric layer on a semiconductor substrate, and forming a semiconductor layer on the dielectric layer. A trench is then etched in the semiconductor layer and the dielectric layer. The trench has a width suitable to form a dielectric waveguide for fiber coupling, and has a bottom adjacent to a surface of the semiconductor substrate. The method further includes placing a low index dielectric layer at a bottom of the trench on the semiconductor substrate. The low index dielectric layer has smaller optical refractive index and thickness than the dielectric layer. The method also includes filling the trench with a dielectric filler of the same dielectric material as the dielectric layer, and removing excess thickness of the dielectric layer, which exposes the semiconductor layer beneath the dielectric layer. A semiconductor taper waveguide is then formed, and a top dielectric layer is placed on the chip. An edge portion of the dielectric layer is then etched at a tip of the semiconductor waveguide, which exposes a surface portion of the semiconductor substrate and three edges of the dielectric layer.

In accordance with yet another embodiment, a method for fabricating a photonic chip includes placing a dielectric layer on a semiconductor substrate, forming a semiconductor waveguide on the dielectric layer, and placing a second dielectric layer on the dielectric layer and the semiconductor waveguide. The method further includes forming a dielectric waveguide from an edge of the second dielectric layer and the dielectric layer using lithography processes, flipping the photonic chip, and removing the semiconductor substrate, wherein the removing exposes a surface of the dielectric layer and the dielectric waveguide. The photonic chip is then placed on a dielectric carrier.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a coupling mismatch between a silicon waveguide of a photonic chip and an optical fiber;

FIG. 2 illustrates a typical photonic chip design for waveguide edge coupling to an optical fiber;

FIG. 3 illustrates an embodiment photonic chip design with enhanced edge coupling efficiency to optical fiber;

FIG. 4 illustrates an embodiment process for making the photonic chip of FIG. 3;

FIG. 5 is a flowchart of an embodiment method corresponding to the process of FIG. 4;

FIG. 6 illustrates another embodiment photonic chip design with enhanced edge coupling efficiency to optical fiber;

FIG. 7 illustrates an embodiment process for making the photonic chip of FIG. 6; and

FIG. 8 is a flowchart of an embodiment method corresponding to the process of FIG. 7.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

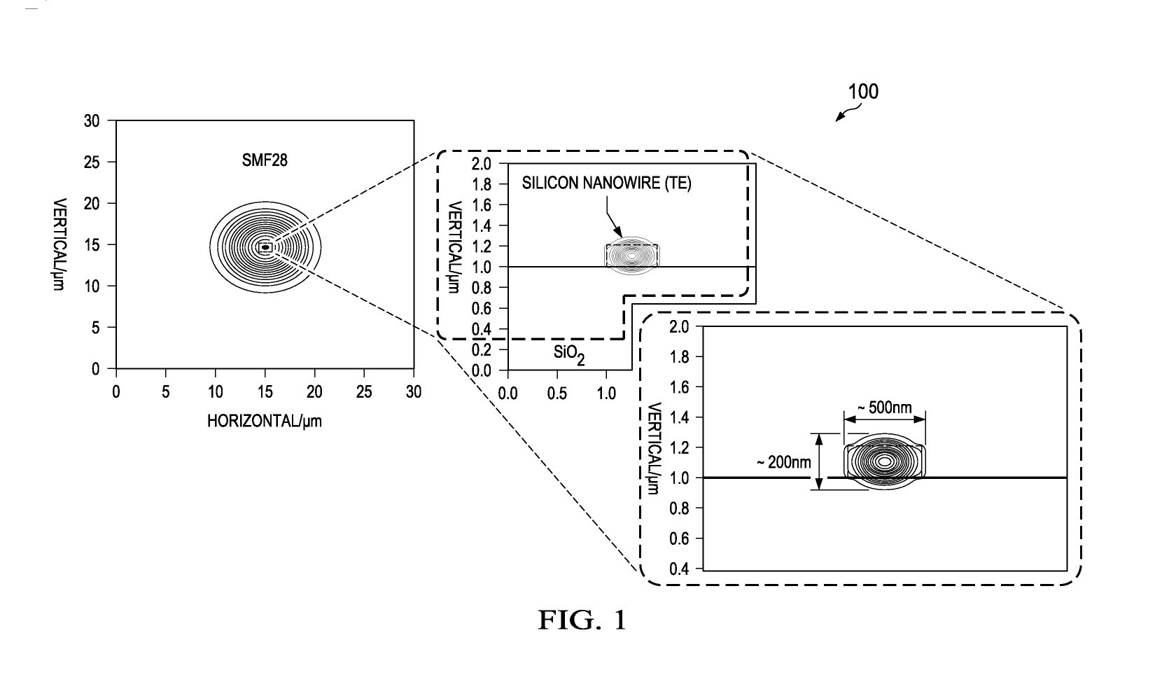

FIG. 1 shows a coupling mismatch scenario 100 between a silicon waveguide of a photonic chip and an optical fiber, e.g., a SMF28 type fiber. The nanowire is a silicon (Si) waveguide on a silicon oxide (SiO2) (in a chip) and has a cross section substantially smaller than the optical fiber. For example, the waveguide has a rectangular cross section with about a 500 nm width and about a 200 nm height. At the interface between the waveguide and the fiber, the MFD of the waveguide, for instance for the TE mode, is substantially smaller than that of the fiber, which is referred to as coupling mismatch and leads to substantial loss of optical power transfer from the waveguide to the fiber.

Embodiments are provided herein to improve coupling efficiency (reduce coupling mismatch) between a silicon chip waveguide and an optical fiber (or other suitable optical waveguides with comparable MFD to optical fibers). The embodiments comprise adding to the chip a suitable coupling waveguide to minimize the coupling loss at the interface between the chip waveguide and the fiber. The coupling waveguide is added as an interface between the nanowire waveguide and the optical fiber. The design enhances the coupling efficiency by maximizing or increasing the recovering integral between the light propagation modes supported at the waveguide and the fiber. The coupling waveguide can substantially improve the coupling between a narrow silicon wire mode (e.g., for a nanowire) and an optical fiber mode with lower insertion loss.

In optical communications, polarization independent coupling is important since polarization in fiber-based networks is unpredictable and varies randomly with transmissions. This issue requires the coupling waveguide between the waveguide and the fiber to enhance the coupling independent of the light polarization, e.g., to be polarization insensitive. Further, for instance to be compatible with functions for fiber to the home (FTTH), wavelength division multiplexing (WDM) applications, or other optical communications applications, the coupling waveguide is also required to operate properly for a broadband signal range (e.g., for more than a single frequency or a relatively narrow frequency range). Besides the coupling performance, the design of the coupling waveguide may also be based on cost issue, for instance by considering the wafer-level testing capability and the packaging requirements with fiber assembly and thermal management.

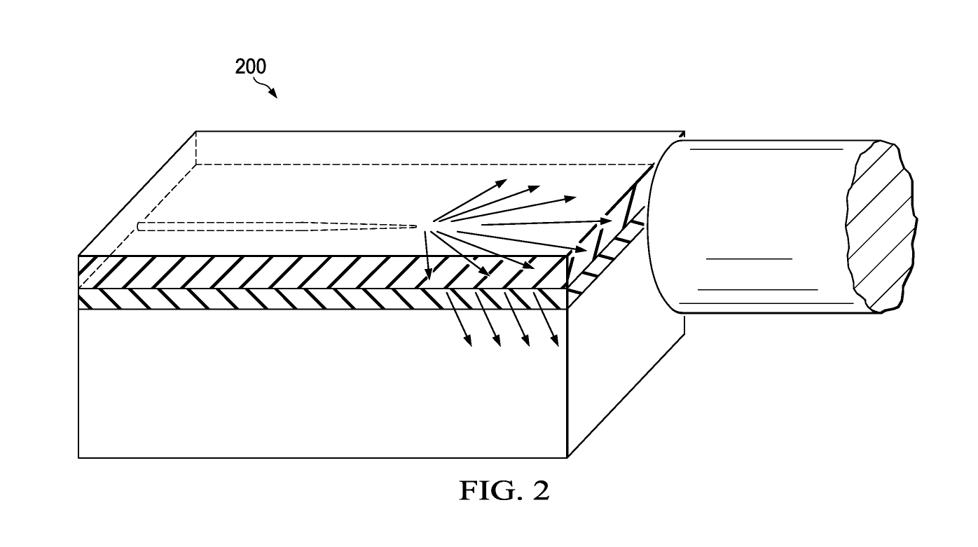

FIG. 2 shows a typical photonic chip design 200 for coupling a chip waveguide to an optical fiber. The design 200 includes an inverted tapered waveguide acting as a chip edge coupler which can satisfy the requirements of lower loss, polarization independent, broadband and lower cost. The edge of the tapered waveguide (taper tip) inside the chip is usually micrometres away from the edge of the chip at the fiber interface, due to fabrication limitation or design requirements. The design 200 also includes a cladding layer under and above the tapered waveguide, e.g., a SiO₂ layer, acting as a propagating media along or at the end of the tapered waveguide. The propagation along the taper waveguide in the SiO₂ enlarges the waveguide mode, which continues to propagate in the SiO2 media at the end of taper tip, then arrives to the fiber. However, the lack of lateral confinement in the SiO₂ layer causes the output light from the taper tip to stray in the cladding layer. In a SOI platform, the cladding layer is on top of a silicon substrate. The high index of the Si substrate causes a large part of output light from the taper tip to penetrate into substrate, which can largely reduce the chip-to-fiber coupling efficiency.

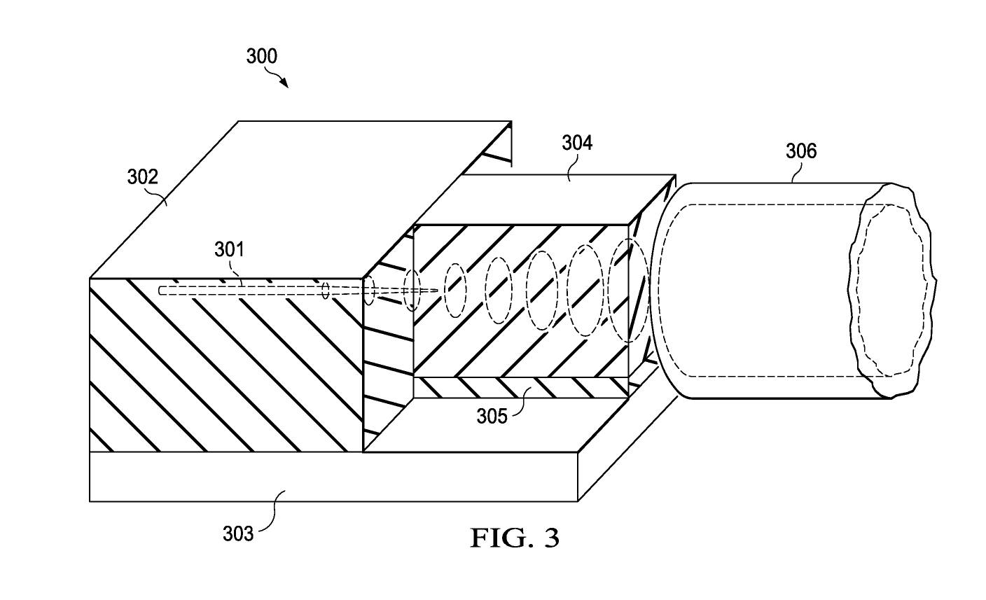

FIG. 3 shows an embodiment photonic chip design 300 with enhanced coupling efficiency to an optical fiber 306. The design 300 includes an inverted taper tip 301 in a SiO₂ cladding layer 302. The inverted tapered waveguide 301, also referred to herein as a taper coupler, is a Si nano-taper embedded in the planar SiO₂ cladding 302. The SiO₂ cladding 302 is a planar layer placed on a Si substrate 303. Additionally, a SiO₂ (silica) coupling waveguide 304 is positioned on the Si substrate 303, serving as a waveguide for coupling between the tapered waveguide 301 and the fiber 306. The tapered waveguide 301 reaches inside the silica coupling waveguide 304. The tapered waveguide 301 can be positioned inside the silica coupling waveguide 304 such that an optical mode from the tapered waveguide 301 is projected onto a center of the silica coupling waveguide 304. Thus, the enlarged optical mode from the tapered waveguide 301 is transmitted by propagating through the silica coupling waveguide 304 to match the MFD of the fiber 306. The silica coupling waveguide 304 serves as an extension of the first silica cladding 302, and provides lateral and vertical confinement for the propagating light from the tapered waveguide 301 to the fiber 306. The effective index of the Si inverted tapered waveguide 301 decreases with the dimension reduction along its length. At the taper tip end, the effective index can reach 1.45 which is close to the refractive index of the silica coupling waveguide 304 (or the silica fiber 306). The propagation mode is hence enlarged to match to the fiber mode, depending on the silica coupling waveguide 304 dimensions. The coupling waveguide 304 has a rectangular cross section with a suitable lateral dimension (width) to properly confine the propagating mode from the tapered waveguide 301 to the fiber 306. Further, to avoid the enlarged propagating mode leaking into the Si substrate 303, a low index cladding layer 305 is placed between the silica coupling waveguide 304 and the Si substrate 303. The low index cladding layer 305 is a suitable material layer with smaller index than silica, such as a Borophosphosilicate glass (BPSG), which prevents or hinders leak of the propagating mode in the silica coupling waveguide 304 to the substrate 303, and hence improves the mode confinement and reduces the light loss at the coupling interface to the fiber. The waveguide 304 dimensions (width and thickness) and the low index cladding layer 305 beneath it ensure that the optical mode is tightly confined in the silica coupling waveguide 304 to the interface with the fiber 306. The cross section and thickness of the silica coupling waveguide 304 can be designed to achieve maximum mode overlap with the fiber 306, e.g., a silica fiber or a lensed silica fiber. In other embodiments, the silicon components of the chip may be formed using other semiconductor materials, such as gallium arsenide (GaAs). The silica material can be substituted by other suitable dielectric materials with lower refractive index than the waveguide core based on silicon or on the semiconductor material used. Further, the coupling waveguide 304 may be composed from a different dielectric material than the cladding layer 302 encasing a portion of the tapered waveguide 301 on the substrate 303.

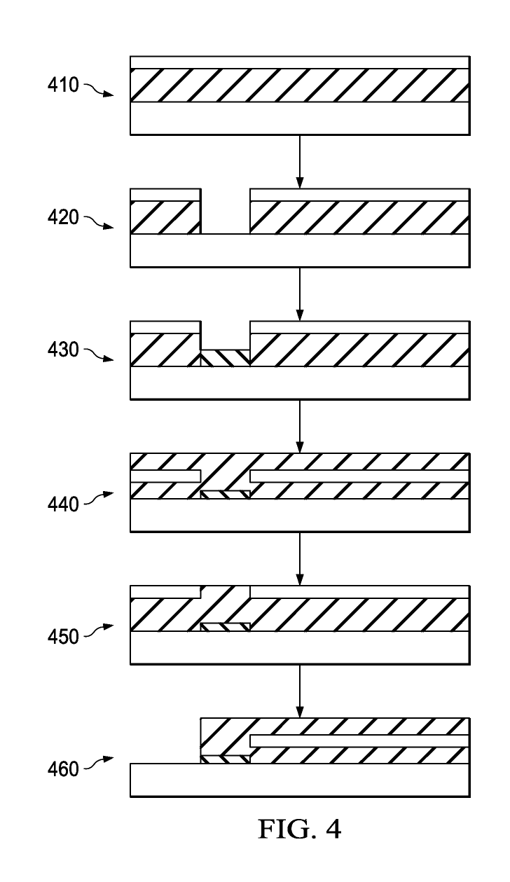

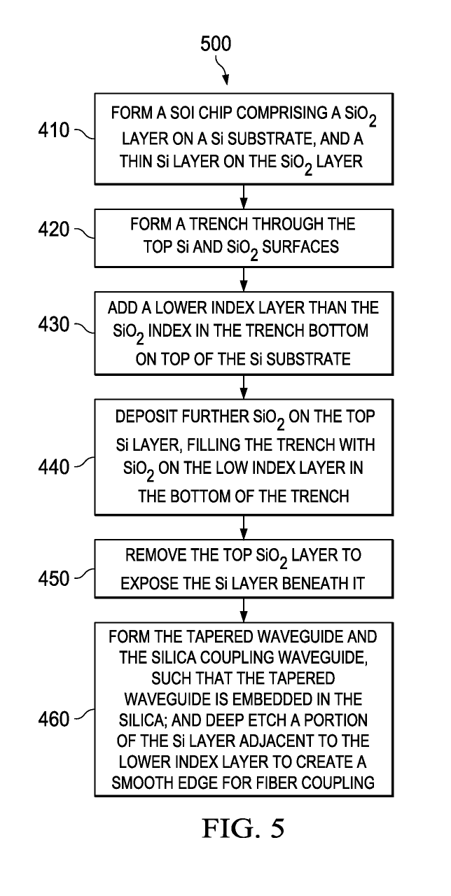

FIG. 4 shows a lateral view of an embodiment process 400 for forming a photonic chip with improved coupling efficiency to optical fiber, according to the photonic chip design 300. FIG. 5 shows an embodiment method detailing the steps of the process 400. At step 410, a SOI chip is formed comprising a SiO2 layer on a Si substrate, and a thin Si layer on the SiO2 layer. At step 420, a trench is formed. The trench is created through the top Si and SiO₂ surfaces using suitable lithographic processes (deposition/exposure and etching). At step 430, a lower index layer than the SiO₂ index is added in the trench bottom on top of the Si substrate. For instance, plasma-enhanced chemical vapor deposition (PECVD) is applied to form a BPSG layer in the trench using a photoresist lifting-off or sol-gel process to produce the lower refractive index layer in the trench. At step 440, SiO₂ is further deposited (overlaid) on the top Si layer, filling the trench with SiO₂ on the low index (e.g., BPSG) layer in the bottom of the trench. At step 450, the top SiO₂ layer is removed to expose the Si layer beneath it. For instance, a chemical mechanical polish (CMP) is applied to remove the top overlaid SiO₂ layer. At step 460, the tapered waveguide (inverted silicon taper) and the silica coupling waveguide (the edge waveguide coupler) are formed, such that the tapered waveguide and other functional devices are embedded in the silica. Multiple processes (including deposition/exposure, etching) can be used to achieve this. This step includes depositing top SiO₂ on the tapered waveguide and trench and a deep etch to obtain the smooth chip edge for fiber coupling. The edge coupler may be formed of SiO₂, as the cladding of the tapered silicon waveguide, or another suitable dielectric material, e.g., silicon nitride or silicon oxynitride. The chip edge is then deep etched to create a smooth edge for fiber coupling.

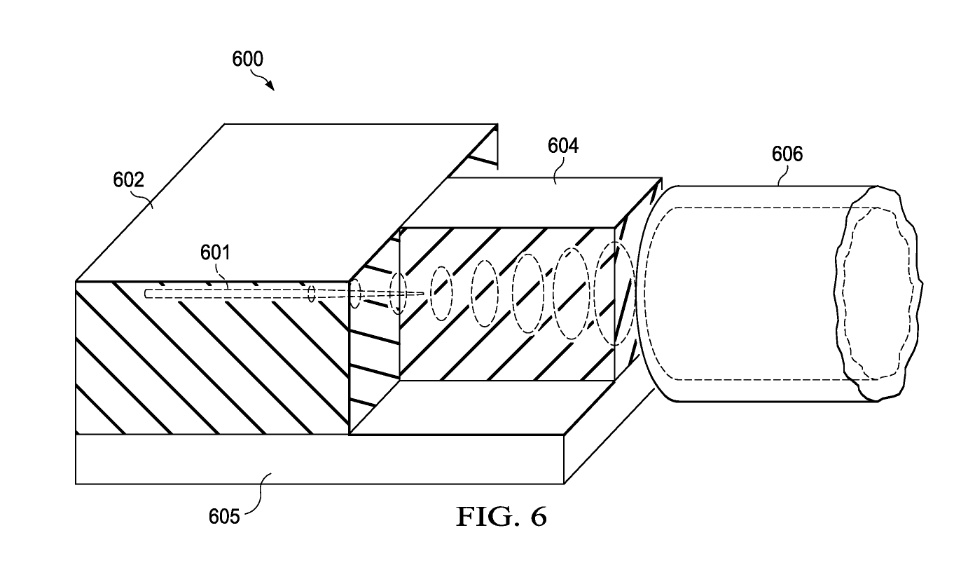

FIG. 6 shows another embodiment photonic chip design 600 with enhanced coupling efficiency to an optical fiber 606. The design 600 includes an inverted taper tip 601 in a first SiO₂ cladding layer 602. The inverted tapered waveguide 601 is a Si nano-taper embedded in the planar SiO₂ cladding 602. The SiO₂ cladding 602 is a planar layer placed on a low index carrier 605 (e.g., a dielectric) in comparison to the index of SiO₂. Additionally, a SiO₂ (silica) coupling waveguide 604 is positioned on the same lower index carrier 605. The silica coupling waveguide 604 serves as a waveguide for coupling between the tapered waveguide 601 and the fiber 606. The tapered waveguide 601 could reach inside the silica coupling waveguide 604. Thus, the enlarged optical mode from the tapered waveguide 601 is propagating through the silica coupling waveguide 604 to match the MFD of the fiber 606. The silica coupling waveguide 604 serves as an extension of the first silica cladding 602, and provides lateral and vertical confinement for the propagating light from the tapered waveguide 601 to the fiber 606. The propagation mode is enlarged to match to the fiber mode, depending on the silica coupling waveguide 604 dimensions. The coupling waveguide 604 has a rectangular cross section with a suitable lateral dimension (width) to properly confine the propagating mode form the tapered waveguide 601 to the fiber 606. Further, the lower index carrier 605 that replaced the silicon substrate prevents the enlarged propagating mode in the coupling waveguide 604 from leaking into substrate, and hence improves the mode confinement and reduces the light loss at the coupling interface to the fiber. The lower index carrier 605 is a suitable material layer with smaller index than silica, such as any suitable low optical index dielectric (with respect to silica) or polymer. The waveguide 604 dimensions (width and thickness) and the lower index carrier 605 beneath it ensure that the optical mode is tightly confined in the silica coupling waveguide 604 at the interface with the fiber 606. The cross section and thickness of the silica coupling waveguide 604 can be designed to achieve maximum mode overlap with the fiber 606, e.g., a silica fiber or a lensed silica fiber. In other embodiments, the silica material can be substituted by other suitable dielectric materials with lower refractive index than the inverted taper tip 601. Further, the coupling waveguide 604 may be composed from a different dielectric material than the SiO₂ cladding layer 602.

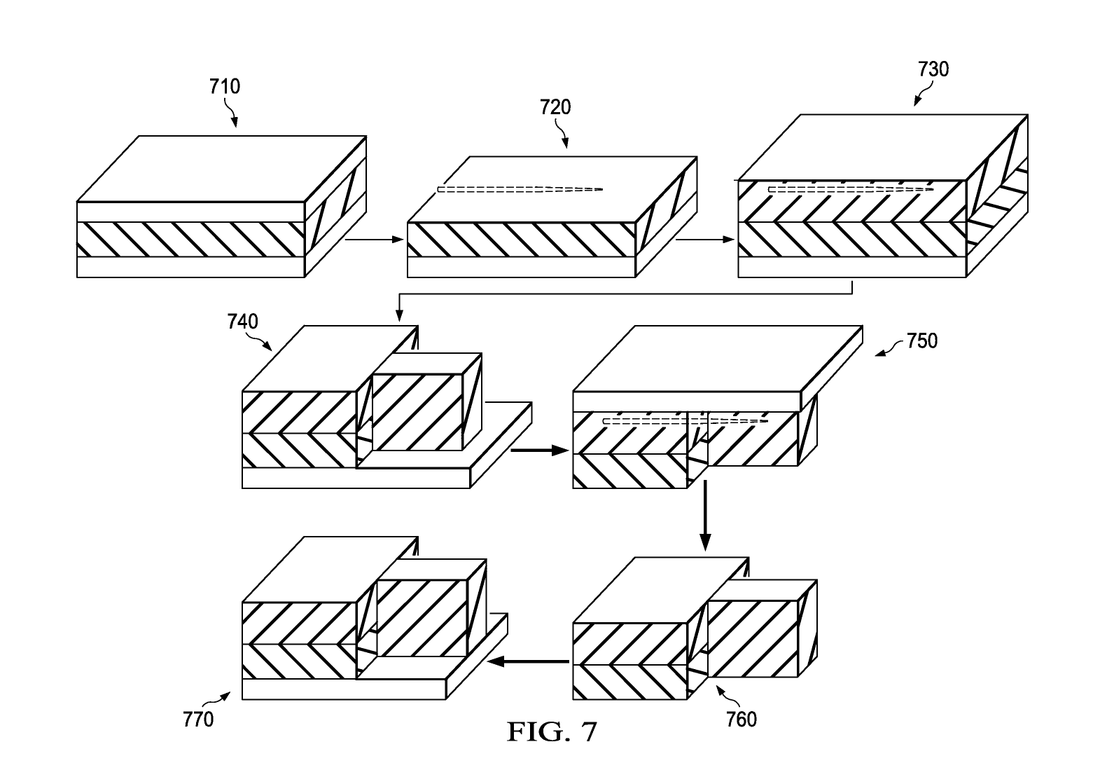

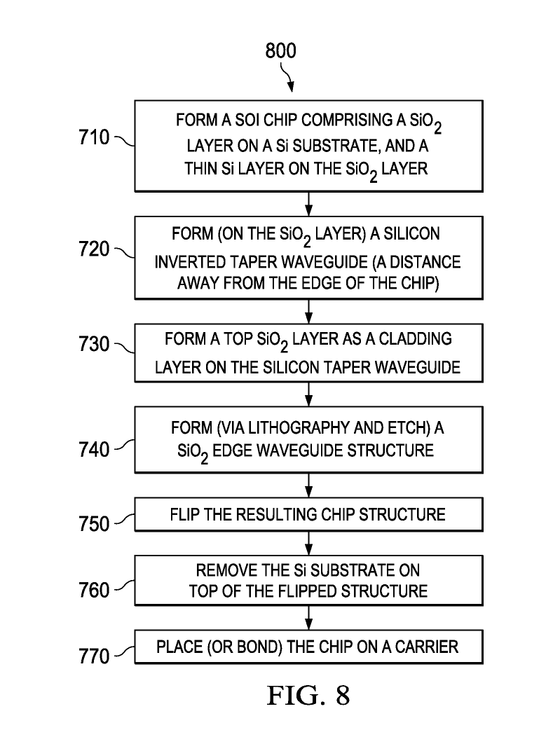

FIG. 7 shows an embodiment process 700 for forming a photonic chip with improved coupling efficiency to optical fiber, according to the photonic chip design 600. FIG. 8 shows an embodiment method detailing the steps of the process 700. In this design, no trench and pre-deposition process is required. The silicon inverted taper waveguide is formed directly on the SOI wafer and enveloped by the silica layer deposition. Silica layer forms the top cladding layer of the taper waveguide. A lower refractive index carrier replaces the high refractive index silicon substrate, preventing the light from leaking outside the waveguide structure. Specifically, at step 710, a SOI chip is formed comprising a SiO2 layer on a Si substrate, and a thin Si layer on the SiO2 layer. At step 720, a silicon inverted taper waveguide is formed on the SiO₂ layer, at a distance away from the edge of the chip. At step 730, a top SiO₂ layer is formed as the cladding layer on the silicon taper waveguide. At step 740, a SiO2 edge waveguide structure is formed, using lithography (exposure and etch) processes. At step 750, the resulting chip is flipped. At step 760, the Si substrate on top is removed, e.g., via CMP. At step 770, the chip is placed on a dielectric carrier, e.g., via a bonding process. In other embodiments, the silicon components of the chip may be formed using other semiconductor materials. The silica material can also be formed using other suitable dielectrics.

Compared to the process of the previously reported mode convertor-based edge coupler, the processes 400 and 700 are simple and easy to implement. They do not need more than one overlay step on the top layer of the final chip. Further, by adjusting the thickness and size of the Si tapered waveguide, the mode size can be controlled. The design could be also extended to applications other than the nano-waveguide chip to fiber coupling. The chip design above eliminates shortcomings of previous solutions, such as the coupling mismatch scenario 100. By controlling the SiO₂ layer thickness, the SiO2 waveguide size can also be designed to maximize the coupling ratio between the waveguide mode and fiber mode. In addition to improving the confinement of the enlarged mode from the tapered waveguide, the silica-based coupling waveguide reduces light reflection from the silica fiber back into the chip. As described above, the design provides low loss coupling, is suitability for broadband, and is polarization independent.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A photonic chip comprising:
a semiconductor substrate;
a dielectric layer on the substrate;
a tapered waveguide embedded in the dielectric layer, wherein the dielectric layer has lower optical refractive index than the tapered waveguide and serves as a cladding for the tapered waveguide; and
on the substrate, a dielectric waveguide adjacent to the dielectric layer, wherein a tip of the tapered waveguide is embedded in the dielectric waveguide.

2. The photonic chip of claim 1 further comprising a second dielectric layer placed between the dielectric waveguide and the substrate, wherein the second dielectric layer is adjacent to the dielectric layer and has a lower optical refractive index than the dielectric layer and serves as a cladding for the dielectric waveguide.

3. The photonic chip of claim 2, wherein the second dielectric layer has a lateral dimension about equal to or larger than a lateral dimension of the dielectric waveguide.

4. The photonic chip of claim 2, wherein the second dielectric layer is comprised of Borophosphosilicate glass (BPSG).

5. The photonic chip of claim 1, wherein the tapered waveguide and the substrate are essentially comprised of silicon.

6. The photonic chip of claim 1, wherein the dielectric layer and the dielectric waveguide are comprised of silicon oxide.

7. The photonic chip of claim 1, wherein the photonic chip is coupled to an optical fiber at an edge of the dielectric waveguide opposite to the dielectric layer.

8. A photonic chip comprising:
a dielectric carrier;
a dielectric layer on the dielectric carrier;
a semiconductor waveguide embedded in the dielectric layer, wherein the dielectric layer has a lower optical refractive index than the semiconductor waveguide and serves as a cladding for the semiconductor waveguide; and
on the dielectric carrier, a dielectric waveguide adjacent to the dielectric layer, and facing the semiconductor waveguide.

9. The photonic chip of claim 8, wherein the semiconductor waveguide is comprised of silicon.

10. The photonic chip of claim 8, wherein the semiconductor waveguide is a tapered waveguide that decreases in width along its length, and wherein a tip of the semiconductor waveguide is embedded in the dielectric waveguide and is narrower than an opposite end of the semiconductor waveguide embedded in the dielectric layer.

11. The photonic chip of claim 8, wherein the dielectric layer and the dielectric waveguide are comprised of silicon oxide.

12. The photonic chip of claim 8, wherein the dielectric waveguide is has a rectangular cross section profile.

13. The photonic chip of claim 8, wherein the dielectric waveguide has a smaller lateral dimension than the dielectric layer.

14. The photonic chip of claim 8, wherein the photonic chip is coupled to an optical fiber at an edge of the semiconductor waveguide opposite to the dielectric layer.

15. The photonic chip of claim 8, wherein the semiconductor waveguide is positioned inside the dielectric layer such that an optical mode from the semiconductor waveguide is projected onto a center of the dielectric waveguide.

16. A method for fabricating a photonic chip, the method comprising:
placing a dielectric layer on a semiconductor substrate;
forming a semiconductor layer on the dielectric layer;
etching a trench in the semiconductor layer and the dielectric layer, wherein the trench has a width suitable to form a dielectric waveguide for fiber coupling, and has a bottom adjacent to a surface of the semiconductor substrate;
placing a low index dielectric layer at a bottom of the trench on the semiconductor substrate, wherein the low index dielectric layer has smaller optical refractive index and thickness than the dielectric layer;
filling the trench with a dielectric filler, wherein the dielectric filler is comprised of a same dielectric material as the dielectric layer;
removing excess thickness of the dielectric layer, wherein the removing exposes the semiconductor layer beneath the dielectric layer;
forming a semiconductor taper waveguide;
placing a top dielectric layer on the chip; and
etching an edge portion of the dielectric layer at a tip the a semiconductor taper waveguide, wherein the etching exposes a surface portion of the semiconductor substrate and three edges of the dielectric layer.

17. The method of claim 16, wherein the semiconductor substrate and the semiconductor taper waveguide are comprised of silicon, wherein the dielectric layer and the dielectric filler are comprised of silica, and wherein the low index dielectric layer is comprised of Borophosphosilicate glass (BPSG).

18. The method of claim 16, wherein the excess thickness of the dielectric layer is removed by chemical mechanical polish (CMP).

19. The method of claim 16, wherein the forming further includes forming other desired function devices, and wherein the top dielectric layer is placed on the semiconductor taper waveguide and the other desired function devices.

20. A method for fabricating a photonic chip, the method comprising:
placing a dielectric layer on a semiconductor substrate;
forming a semiconductor waveguide on the dielectric layer;
placing a second dielectric layer on the dielectric layer and the semiconductor waveguide;
forming a dielectric waveguide from an edge of the second dielectric layer and the dielectric layer using lithography processes;
flipping the photonic chip;
removing the semiconductor substrate, wherein the removing exposes a surface of the dielectric layer and the dielectric waveguide; and
placing the photonic chip on a dielectric carrier.

21. The method of claim 20, wherein forming the semiconductor waveguide comprises:
placing a thin silicon layer on the dielectric layer; and
forming an inverted taper waveguide from the thin silicon at a distance away from the edge of the dielectric layer.
